(19) United States
(12) Patent Application Publication
(10) Pub. No.: US 2014/0152464 A1
(43) Pub. Date: Jun. 5, 2014

(54) Companion Activity Sensor System

(71) Applicant: Integrated Bionics, LLC, Houston, TX (US)

(72) Inventor: Stéphane Louis Smith, Houston, TX (US)

(21) Appl. No.: 13/934,432

(22) Filed: Jul. 3, 2013

Related U.S. Application Data
(60) Provisional application No. 61/697,620, filed on Sep. 6, 2012.

(51) Int. Cl. G08C 17/02

(52) U.S. Cl. CPC G08C 17/02
USPC 340/870.02

(57) ABSTRACT

The present invention relates to compliance monitoring systems for health care monitors and, more particularly, in certain embodiments, to a compliance monitoring system for a mandibular repositioning device. Embodiments may include a system and method for measuring usage data of health care monitor or apparatus.

### CROSS REFERENCE TO RELATED APPLICATIONS

This application is a non-provisional of U.S. application Ser. No. 61/697,620 filed Sep. 6, 2012, which is herein incorporated by reference in its entirety.

### BACKGROUND

The present invention relates to compliance monitoring systems for health care monitors and, more particularly, in certain embodiments, to a compliance monitoring system for a mandibular repositioning device.

Obstructive sleep apnea (OSA) is a common disorder caused by an obstruction of the pharyngeal airway during sleep. Obstructive sleep apnea has been shown to increase daytime fatigue and sleepiness, and patients with untreated OSA have statistically higher incidents of motor vehicular accidents. It has also been linked to an increased incidence of neurocognitive dysfunction, cardiovascular disease, and stroke.

In treatment, the afflicted person may wear a mandibular repositioning device (MRD) during sleep to alleviate this obstruction. Mandibular repositioning devices function to protrude the mandible forward when worn, thereby lifting the soft tissue from the obstructed airway. These devices are typically prescribed by a dentist and may be custom fit to each patient.

Some patients may not use the MRD as often as required because they feel it is uncomfortable or bothersome to use, because it requires too much time, because they forget, and so on. Thus, a compliance monitoring system (CMS) may be used in conjunction with an MRD and may also be integrated with the device. The CMS may be a device worn by the patient to ensure compliance with the prescribed regimen of MRD use. The CMS may allow a health care professional and/or the patient to track the usage of the device (i.e. when it is worn) by recording data pertinent to metrics that indicate changes in the device state using the CMS's sensors. This data tracks MRD usage by measuring when the MRD is inserted into a patient's mouth and when the MRD is removed from a patient's mouth. This data may be used by health care professionals and the patient to ensure the wellbeing of the patient by monitoring whether the patient is following the prescribed MRD usage plan suggested by their health care professional. Additionally, the CMS may also provide data useful for analyzing the effectiveness of the mandibular repositioning device and therefore facilitate device improvement. Furthermore, insurance companies may be more willing to cover costs associated with MRD therapy if patient compliance can be reliably confirmed.

Tradeoffs exist when designing integrated dental sensing devices such as a CMS. For example, a thermocouple sensor has been used previously in the field to measure temperature data as a useful indicator of device activity. However, temperature data is prone to false positives or false negatives due to ambient temperature variation. Because of this ambient temperature variation, a high sampling rate of data is necessary to distinguish the ambient temperature variations from a temperature change that would indicate usage of the MRD. In other words, the more data points collected around the time period of a transition event, the easier it will be to distinguish the transition event signal from any ambient noise. High sampling rates enable sophisticated data processing techniques, such as spectrum analysis and filtering, which enable the data processing software to perceive the actual signals of device usage. However, high sampling rates directly impact the other performance metrics. More memory may be required to store the sampled data. Electronic device components are on more frequently, thus drawing more power. Consequently, a larger battery may be implemented or the monitoring duration may be shortened. A larger battery may increase the form-factor making the device more difficult for intra-oral use. The device cost may also be increased to account for the extra hardware required to support the sampling rate. An activity sensor sampling at relatively high rates would thereby compromise at least one of power, battery size, form factor, cost, memory, and so on.

Various types of CMS's have been proposed for use with MRD's to solve some of these issues. However, all of them experience some form of drawback. Some CMS's utilize only one type of sensor to cut down on power, memory, and cost. However, these systems are prone to reporting false positives when external stimuli influence the measurement of the data. Other systems may utilize multiple types of sensors to reduce the occurrence of false positives, yet these multiple sensors do not work synergistically, and may increase the power and memory needs of the CMS which can negatively impact the form-factor and cost of the device. As a result, the current model of CMS's may provide potentially inaccurate data or they require so much energy and maintenance that they are a burden for the patient and the health care professional.

### SUMMARY

The present invention relates to compliance monitoring systems for health care monitors and, more particularly, in certain embodiments, to a compliance monitoring system for a mandibular repositioning device.

An embodiment may comprise a compliance monitoring system comprising: a primary sensor, a companion sensor, a non-volatile memory, and a micro-controller, wherein the compliance monitoring system is configured for and capable of measuring usage data of a healthcare monitor or apparatus.

Another embodiment may comprise a method for determining the amount of usage of a mandibular repositioning device comprising: providing at least one primary sensor, providing a companion sensor, providing a non-volatile memory, providing a micro-controller, wherein the primary sensor, the companion sensor, the non-volatile memory, and the micro-controller comprise a compliance monitoring system, wherein the primary sensor takes measurements at a default nominal sampling rate, wherein the companion sensor modulates the sampling rate of the primary sensor, wherein the micro-controller collects data from the primary and companion sensors and stores the collected data on the non-volatile memory.

Another embodiment may comprise a method for determining the amount of usage of a mandibular repositioning device comprising: providing at least one primary sensor, providing a companion sensor, providing a non-volatile memory, providing a micro-controller, wherein the primary sensor, the companion sensor, the non-volatile memory, and the micro-controller comprise a compliance monitoring system, wherein the primary sensor takes measurements at a default nominal sampling rate, wherein the companion sensor modulates the sampling rate of the primary sensor, wherein the micro-controller collects data from the primary and companion sensors and stores the collected data on the non-volatile memory; wherein at least one of the primary sensors is selected from the group consisting of a thermocouple, a pressure sensor, an accelerometer, an electro-chemical sensor, a gyroscope, a ph meter, a pulse oximeter, a bio-chemical sensor, humidity sensor, microphone, vibration sensor, or any combination thereof; wherein the companion sensor is selected from the group consisting of a magnet with magnetic relay, a piezoelectric sensor, a mechanical switch, an electromagnetic field generator with antenna, or an orientation tilt sensor; wherein the collected data is data analyzed by a data processing technique performed by the compliance monitoring system, by a separate data processing device, or by a combination of the two; wherein the data processing technique is at least one technique selected from the group consisting of: comparing each data point to a figure of merit, using spectral analysis techniques such as the Fourier transform or periodogram to compare power within a frequency band against a figure or merit, taking the derivative of the sampled data and comparing it to a figure of merit, calculating the time-constants of the transition and comparing them with a pre-determined level; wherein the output of the data processing technique comprises mandibular repositioning device usage data; wherein transmission of any data is done by at least one method selected from the group consisting of active RF, RFID, a wire, an infrared link, an optical link, and any combination thereof; and wherein the mandibular repositioning device usage data is transmitted such that it may be viewed by a physician, a patient, or a combination thereof.

The features and advantages of the present invention will be readily apparent to those skilled in the art. While numerous changes may be made by those skilled in the art, such changes are within the spirit of the invention.

### BRIEF DESCRIPTION OF THE DRAWINGS

The following figures are part of the present specification, included to demonstrate certain aspects of embodiments of the present disclosure and referenced in the detailed description herein. Unless otherwise noted, figures are not drawn to scale.

FIG. 1A is an illustration of an embodiment of the compliance monitoring system with a primary and companion sensors attached to a mandibular repositioning device,

FIG. 1B is an illustration of an embodiment of the compliance monitoring system from a top-down perspective of a mandibular repositioning device with a compliance monitoring system attached,

FIG. 2 is an illustration of a schematic of an embodiment of the compliance monitoring system,

FIG. 3 is an illustration of an embodiment of companion sensor,

FIG. 4 is an illustration of an alternative embodiment of companion sensor,

FIG. 5 is a flowchart depicting the triggering response of a primary sensor in accordance with example embodiments,

FIG. 6 is a flowchart depicting the modulation of primary sensors and the data collection and data processing of all sensor data in accordance with example embodiments,

FIG. 7A illustrates a graph of primary sensor sampling without modulation by a companion sensor in accordance with example embodiments,

FIG. 7B illustrates a graph of primary sensor sampling with modulation by a companion sensor in accordance with example embodiments,

FIG. 8 illustrates a flowchart of an embodiment of a method of data processing for the collected sensor data,

FIG. 9 illustrates an embodiment of four methods of data processing for the collected sensor data,

FIG. 10A is an example of a graph of collected sensor data that indicates a false positive,

FIG. 10B is an example of a graph of collected sensor data that filters a false positive.

### DETAILED DESCRIPTION

The principles of the invention are explained by describing in detail, specific example embodiments of devices, systems, and methods for extended measurement of data and the application of treatment from portable sensors worn on the human body.

The CMS may function by detecting device activity using the combination of a primary sensor and companion sensor. The primary sensor may sample important metrics associated with the device state and also track associated time signals to record and measure MRD usage. The primary sensor may comprise a thermocouple which may measure temperature, a pressure sensor which may measure force, an accelerometer which may measure acceleration, an electro-chemical sensor which may measure saliva impedance, a gyroscope which may measure orientation, a ph meter which may measure acidity or alkalinity, a pulse oximeter which may measure biological vital signs, a bio-chemical sensor which may detect the presence of affinity based bio-markers, a humidity sensor which may measure water vapor, microphone which may measure sound, a vibration sensor which may measure mechanical oscillation, or any combination thereof. It is to be understood that the choice of a primary sensor is not to be limited to the sensor types discussed in this disclosure, but may include any sensor type as would occur to one with skill in the art.

Embodiments of the companion sensor may generate binary data which can be independently recorded and analyzed, and also used to modulate the sampling rate of the primary sensor(s) in a synergistic relationship. The companion sensor may be a passively operated sensor. It optimally requires relatively little to no power from the CMS to operate. The companion sensor modulates the sampling rate of the primary sensor by asynchronously interrupting the micro-processor which is responsible for operation of the primary sensor. The companion sensor may be implemented as a magnetic relay which is a magnetic sensor that detects the presence of a magnetic field, a piezoelectric sensor which detects the presence of force, a mechanical switch which detects the presence of an electrical short, an antenna which detects the presence of a specific or range of radio frequencies, an orientation tilt sensor which detects the presence of change in relative orientation, or any combination thereof. It is to be understood that the choice of the companion sensor is not to be limited to the sensor types discussed in this disclosure, but may include any sensor type as would occur to one with skill in the art. A single companion sensor may modulate one or many primary sensors. This modulation determines the rate of data sampling of the primary sensor, and therefore the frequency and time with which data collection is occurring. Additionally, the processor collects the companion sensor's data which is independent of the primary sensor data. In an embodiment the companion sensor data is binary data. The companion sensor data may be processed along with the primary sensor data to determine the specific device activity at any given time. This activity may be characterized as a device state. Example device states may include an installed state (e.g. when the MRD is worn), an uninstalled state (e.g. when the MRD is not worn), and a transitional state (e.g. when the MRD is in process of being inserted or removed). The data tracked by the primary sensor(s) and the companion sensor(s) may be processed to provide a log of device states over a time interval. This data processing may occur on the MRD in real time, may occur on a separate data processing device with a real time transfer of the data, or the data processing may occur at a later time by transferring the recorded data to a separate data processing device with data analysis software installed such as a workstation, laptop, smart phone, base station, a proprietary device specifically configured for such a purpose, or the like. The processed data may direct the MRD or associated device to directly perform a treatment action as prescribed by a physician, or in the alternative, the MRD or associated device may notify either the patient or the physician to perform the treatment action.

In certain embodiments, the primary sensor is located on the CMS, located on the MRD. However, the components forming the companion sensor may be themselves separated and consequently located on separate configurations or locations (e.g. a magnet may be located on the upper MRD member and the magnetic relay may be located on the lower MRD member, or an RF generator may be located on the base stations and an RF antenna may be located on the MRD). One having ordinary skill in the art will be able to choose the appropriate companion sensor and place it in the appropriate configuration for a given application.

Generally, embodiments of the present invention include an apparatus and a method for the extended measurement of data from portable sensors worn on an MRD or located elsewhere. The method includes nominally sampling data from a primary sensor at a default sampling rate and, in response to receiving a trigger signal, sampling data from the sensor at a higher rate. The trigger signal may be indicative of a change of activity making the higher sample rate desirable, such as, for example: to increase accuracy, to avoid dangerous delay, or to avoid aliasing problems. The trigger signal may result from the primary sensor reaching a threshold value in its measurement or it may result from the tripping of a companion sensor which in turn modulates the sampling rate of the primary sensor.

A first general embodiment may be a CMS used for the extended monitoring of metrics. These metrics may comprise temperature, force, impedance, acceleration, biological vital signs, orientation, bio-chemical presence, sound, humidity, vibration, and the like. The CMS may comprise a primary sensor; a non-transitory storage medium; a companion activity sensor; and a micro-controller. Additionally, the CMS may comprise multiple primary sensors and/or multiple companion sensors. A sole companion sensor can modulate one or more primary sensors. The micro-controller may be configured to take measurements from the primary sensor at a nominal rate until receiving a triggering signal from the primary sensor or the companion sensor. The micro-controller may also be configured to take measurements at the higher burst rate for a predetermined period; and store the measurements on the non-transitory storage medium in response to receiving the triggering signal. Alternatively, the monitor may include a communication module such as an RF transmitter and may transmit the measurements via the transmitter instead of, or in addition to, recording the measurements. The recorded measurements may be transmitted or otherwise transferred at a later time. The measurements may be transferred to a data processing device for processing to determine compliance. Processing may take place on an automatic or interactive basis. Examples of suitable data processing devices include, without limitation, computers including tablets and mobile devices as well as specific devices designed only for data processing.

Another general embodiment may be a CMS for use in an MRD. The CMS system monitors target metrics that are helpful in determining MRD usage. These metrics may comprise temperature, force, impedance, acceleration, biological vital signs, orientation, bio-chemical presence, sound, humidity, vibration, and the like. The CMS may comprise a primary sensor; a non-transitory storage medium; a companion activity sensor; and a micro-controller. Additionally, the CMS may comprise multiple primary sensors and/or multiple companion sensors. A sole companion sensor can modulate one or more primary sensors. The micro-controller may be configured to take measurements from the primary sensor at a nominal rate until receiving a triggering signal from the primary sensor or the companion sensor. The micro-controller may also be configured to take measurements at the higher burst rate for a predetermined period; and store the measurements on the non-transitory storage medium in response to receiving the triggering signal. Alternatively, the CMS may include a communication module such as an RF transmitter and may transmit the measurements via the transmitter instead of, or in addition to, recording the measurements. The recorded measurements may be transmitted or otherwise transferred at a later time. The measurements may be transferred to a data processing device for processing to determine compliance. Processing may take place on an automatic or interactive basis. Some embodiments may monitor compliance of patients using MRDs for the treatment of obstructive sleep apnea.

Aspects of the present invention may overcome sampling limitations to achieve low-power, small form-factor and/or high performance sensors. Anticipated uses of these sensors may include various medical applications.

Other embodiments include companion activity sensors for dental applications generally, including telemetry and remote sensing applications, remote treatment and notification of serious conditions, or to other medical devices worn on or in the body generally, and to compliance monitors in the dental field extending to areas of prosthodontics and orthodontics, as well as sleep medicine, such as Continuous Positive Airway Pressure (CPAP) devices.

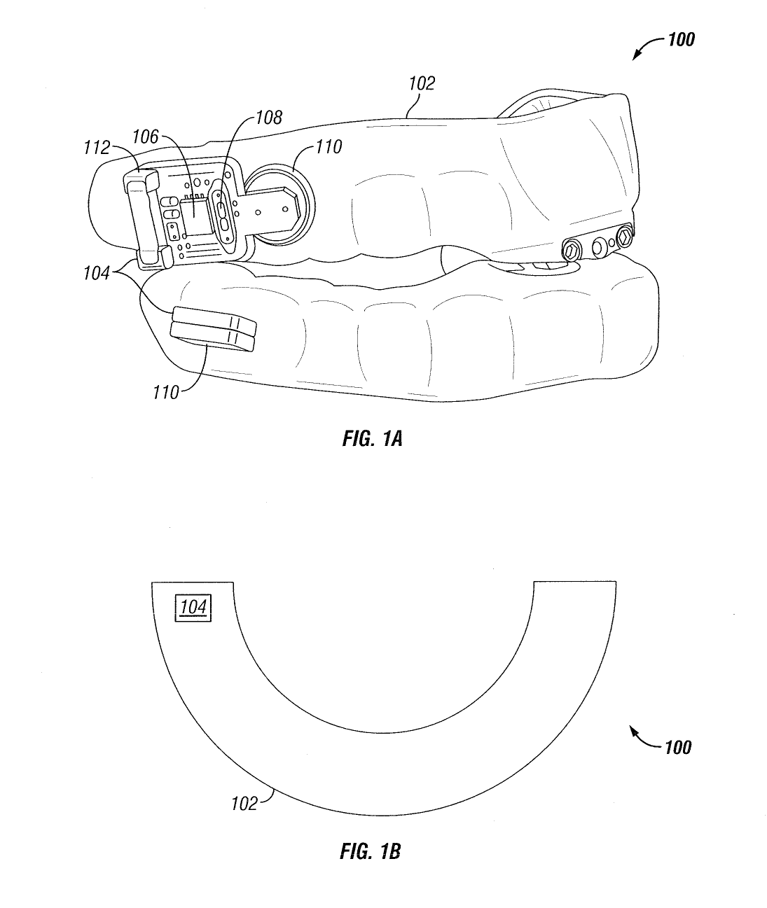

FIGS. 1A and 1B illustrate an example CMS attached to an MRD in accordance with embodiments of the invention. FIG. 1A illustrates a perspective view of the example MRD. FIG. 1B illustrates an overhead schematic view of the example MRD. As seen in FIGS. 1A and 1B, the MRD 100 has a body 102 and a CMS 104. The body 102 is configured to be worn on teeth of a patient so as to protrude the mandible forward, thereby lifting the soft tissue from the patient's obstructed airway. The CMS 104 comprises a system on a chip (SoC) micro-processor with an embedded primary sensor 106 (e.g. a temperature sensor) and a two-component companion sensor with one component a magnetic relay 108 and the other a magnet 110. The magnetic relay 108 component of the companion sensor detects the presence of the magnet 100 component of the companion sensor. The absence or presence of the magnet is recorded as binary data. The companion sensor configuration presented in this embodiment does not require power from the CMS to operate. In this embodiment, both sensors are embedded into the maxillary portion of body 102. The CMS 104 detects conditions indicative of the usage of the MRD 100. For example, the CMS 104 may sample metrics (temperature, moisture, galvanic response, etc.) measured at or near the MRD using the CMS 104's primary and companion sensors. CMS 104 is configured to detect when the MRD 100 is inserted into the mouth of the patient. In this embodiment, the SoC micro-processor with an embedded primary sensor 106 is powered by a battery 110. An RF antenna 112 may transmit the data collected by the primary sensor and the binary data collected by the companion sensor for processing and/or analysis. As discussed above, the data tracked by the primary sensor(s) and the companion sensor(s) may be processed to provide a log of device states over a time interval. This data processing may occur in the CMS in real time, may occur on a separate data processing device with a real time transfer of the data, or the data processing may occur at a later time by transferring the recorded data to a separate data processing device with data analysis software installed such as a workstation, laptop, smart phone, base station, a proprietary device specifically configured for such a purpose, or the like.

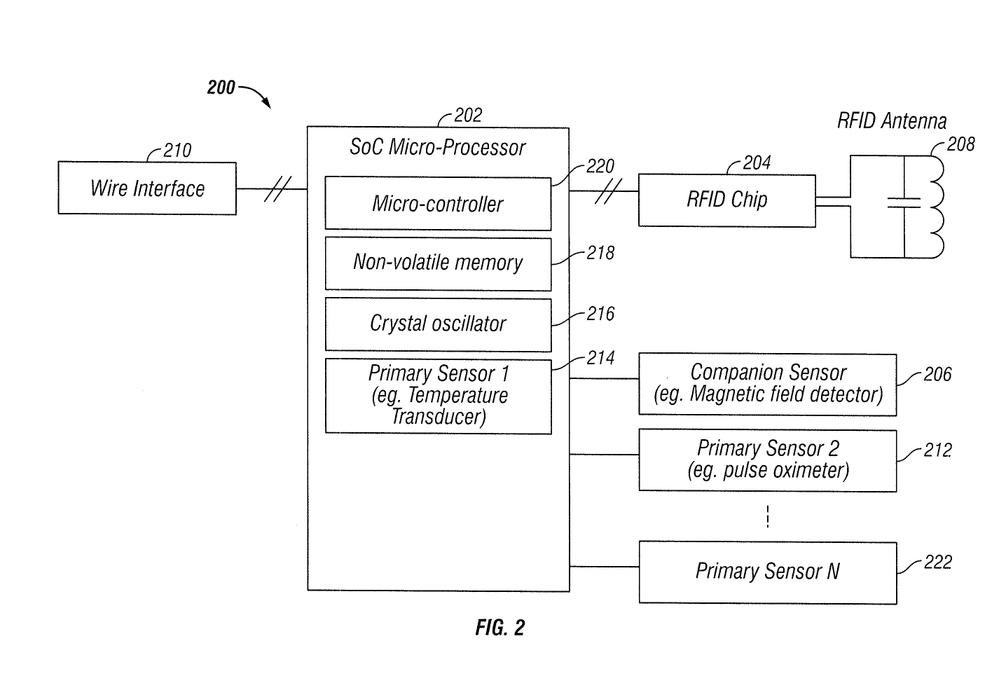

FIG. 2 illustrates a schematic of an example CMS 200 in accordance with embodiments of the invention. The example CMS 200 includes a system on a chip microprocessor 202 having an integrated primary sensor 1 214 (e.g., a temperature transducer), micro-controller 220, non-volatile memory 218, and a crystal oscillator 216. Alternatively, the primary sensor may be discrete and therefore located elsewhere on the MRD. The CMS may be hermetically sealed for intra-oral use. Although the primary sensor 1 as an example is suggested as a thermocouple, in other embodiments, other sensors may be used in accordance with the metric to be measured and recorded as described above. With the benefit of this disclosure, one having ordinary skill in the art will be able to choose the appropriate primary sensor and the appropriate configuration of the sensor on the MRD for a given application. The CMS 200 further includes a non-volatile memory 218 such as a flash or EEPROM memory, a crystal oscillator 216, an RFID chip 204 which functions as a communications module, primary sensor 2 212 (e.g. a pulse oximeter) which is discrete from the SoC micro-processor 202 and not integrated like primary sensor 1 214, and a companion activity sensor 206 (e.g., a magnetic field sensor); alternative embodiments depict an RFID antenna 208, and a wire interface 210 for transmitting and/or receiving data via the communications module 204. Alternative embodiments may also include primary sensor N 222, which depicts the potential inclusion of additional primary sensors. The SoC microprocessor 202 may be configured to store measurements from one or more sensors (e.g., analog or digital signals) as information on non-volatile memory. The data is stored onto the non-volatile memory and thus a full history of the appliance's use is recorded. Alternatively, the monitor may include a communication module such as an RF transmitter and may transmit the measurements via the transmitter instead of, or in addition to, recording the measurements.

Once the data has been collected and/or stored, the data may then be transferred to a data processing device (not shown) for processing. Communication to a data processing device may be achieved through the communications module 204 via any practical method including active RF (e.g. WiFi, Bluetooth®, 3g, and the like), RFID (e.g. both active and passive as well as low and high frequency and the like), a wire interface (e.g. usb, Ethernet, serial interface, and the like), an infrared or optical link (LED's and the like), and/or any other suitable data transfer type, device, or method. The data processing device may be implemented as any computing device having a processor and memory and configured to receive recorded data from the CMS 200. The data processing device may process the data to determine the history of use and/or compliance, as well as perform data management and user interface functions. The data processing device may additionally take action depending on the processed data. The action may either direct the device to provide treatment or notify the physician or patient of the current status and request treatment be administered.

CMS 200 has at least two sampling rates for recording data. The CMS 200 may have one or more nominal rates. The nominal rate is a default, lower sampling rate. The CMS 200 also has a higher sampling rate (‘burst rate’) configured for use during a target period of activity. The companion sensor 206 may be used to modulate the sampling rate. As discussed above, the companion sensor 206 may be implemented as a magnetic relay which is a magnetic sensor that detects the presence of a magnetic field, a piezoelectric sensor which detects the presence of force, a mechanical switch which detects the presence of an electrical short, an antenna which detects the presence of an electromagnetic signal, an orientation tilt sensor which detects the presence of change in relative orientation, or any combination thereof. The companion sensor functions 206 as a binary operation. When the companion sensor is tripped, for example: a magnetic relay sensor registers the presence of or the removal of a magnetic field (depending on the configuration); the device is put in active mode where burst sampling by the primary sensor 1 214 on the SoC Micro-processor 202 and the primary sensor 2 212 (e.g., a pulse oximeter), as well as any other primary sensors (e.g. primary sensor N 222), is performed. After a period of time, primary sensor 1 214 on the SoC Micro-processor 202 and primary sensor 2 212 transition back into idle mode where sampling is performed at a slower nominal rate. The period of time may be fixed, or may vary as a function of the measurements, the time of day, or combinations of the same and the like. Conversely, and still as an example, when the magnetic relay registers the opposite event (removal or presence of a magnetic field, again depending on the configuration of the companion sensor), active mode is again triggered and further burst sampling by primary sensor 1 214 on the SoC Micro-processor 202 and primary sensor 2 212 is performed. Likewise, this second burst sampling is limited in time and the primary sensor on the SoC Micro-processor 202 and primary sensor 2 212 will revert to idle mode and consequently a nominal sampling rate as determined by a function of the measurements, the time of day, or combinations of the same and the like.

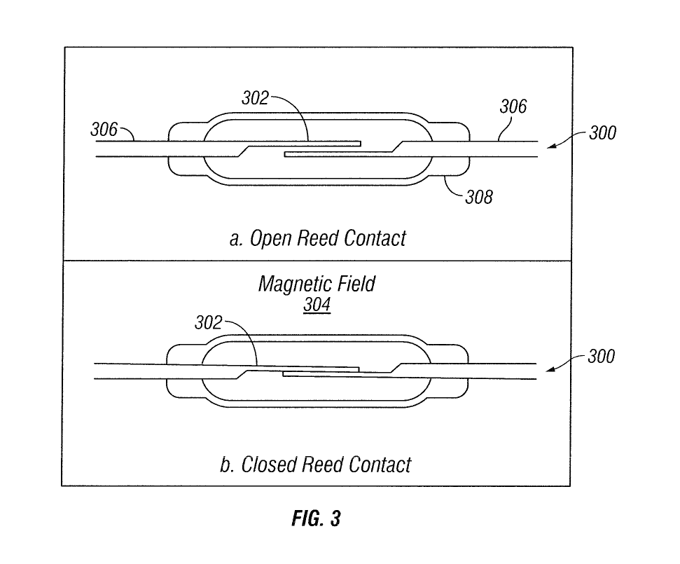

FIG. 3 illustrates an example companion sensor in accordance with embodiments of the invention. The companion sensor 300 comprises a magnetic reed relay 302, a rare-earth magnet 304, contacts 306, and hermetic seal 308. The rare-earth magnet 304 is attached to a mandibular member, such as a tooth, to trigger the magnetic reed relay 302. The CMS is configured such that when the MRD is connected in the proper orientation, the magnet's field engages the magnetic reed relay. The presence of a magnetic field from the magnet 304 induces the contacts 306 to engage each other, signaling a triggering event and tripping the companion sensor. Conversely, when the two contacts 306 are separated, the absence of the magnetic field again triggers the relay but through the reverse mechanism as described above. The companion sensor 300 may be hermetically sealed as shown by hermetic seal 308.

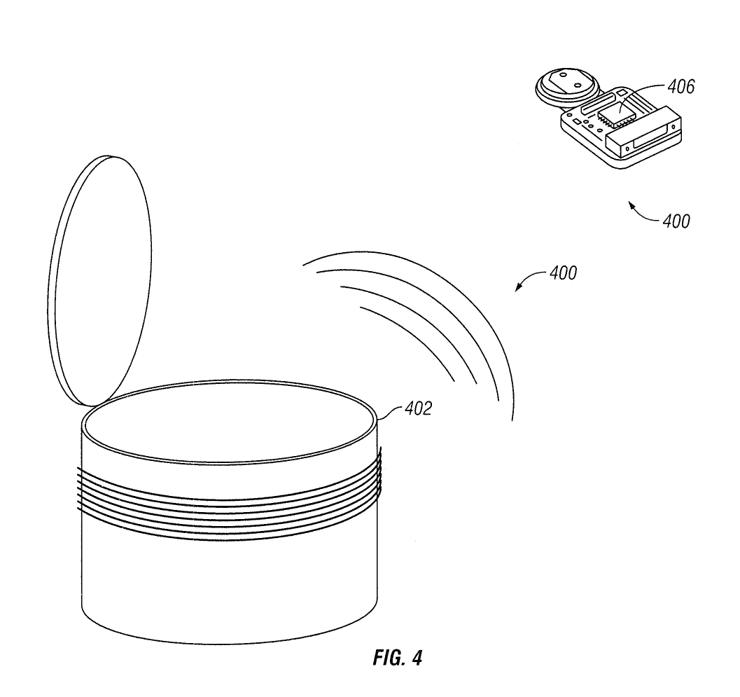

FIG. 4 is an alternative embodiment of a companion sensor 400; the companion sensor 400 is again composed of two separate components, similar to the companion sensor embodiment of FIG. 3. Component 1 is an RFID field generator 402 located on a base station 404. Component 2 is a RF field detector 406 located on the CMS which trips the primary sensor (not shown) when the MRD is close enough to detect the RF field or conversely far enough away to not detect the RF field generated by the base station's RF field generator 402.

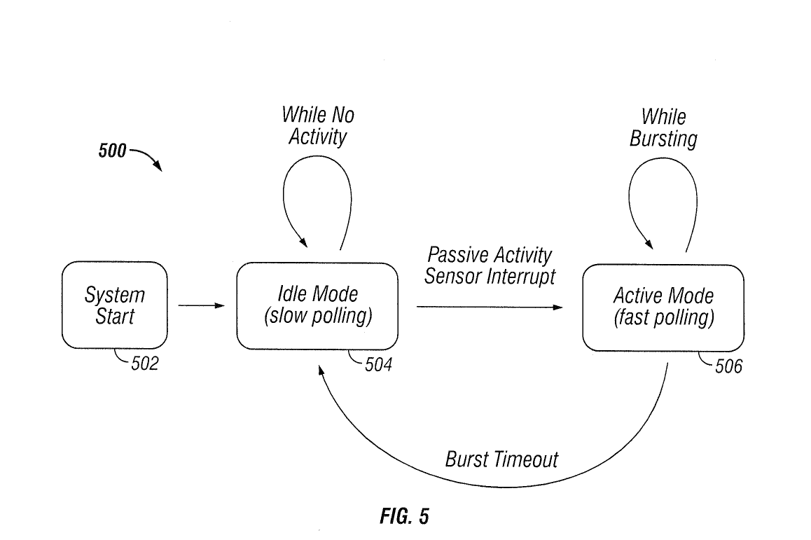

FIG. 5 illustrates a flowchart of primary sensor sampling modulation in accordance with embodiments of the invention. The CMS system 500 is activated via the system start operation of block 502. With not triggering events, the system enters idle mode as shown by block 504. The idle mode 504 is the time when there is little or no activity for the device to sample. For example, for a device that is designed to be worn at night, there may be no activity during the day. Thus, the time-constant and bandwidth of the system may be very long, on the order of many hours. The CMS may be configured to use the lower default rate during this period. After a triggering event is registered, the CMS system 500 enters active mode 506; this triggering event may occur because the device is being inserted or removed from the mouth and the metrics of the system are actively changing. During this active mode 506, the primary sensor samples at the full burst rate to avoid aliasing. After the system has stabilized, so that there is minimum fluctuation in the target metrics, the device may return to idle mode 504 and the default nominal sampling rate.

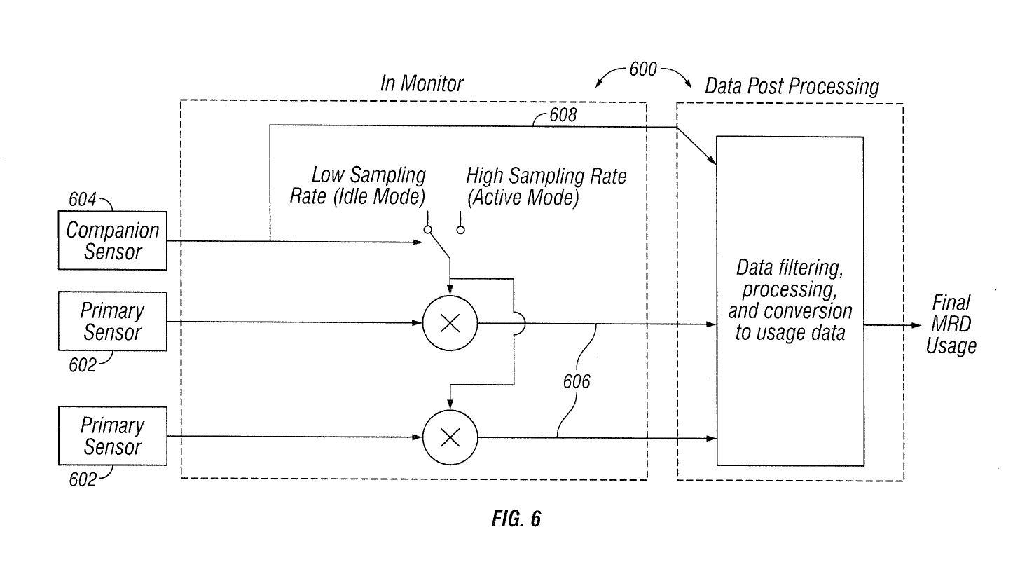

FIG. 6 is a diagram depicting the flow of data within CMS 600 in accordance with embodiments of the invention. CMS 600 may be integrated into a dental device such as an MRD, which is used as the example device in FIG. 6. CMS 600 comprises two primary sensors 602 and one companion sensor 604. The companion sensor 604 modulates the sampling rate (i.e. low/high or in other words idle/active) of the primary sensors 602. This modulation may occur in the CMS monitor portion of the CMS 600. The companion sensor 604 may trip asynchronously from the rest of the CMS 600. The companion sensor 604 may be a passive sensor. If configured as a passive sensor, the companion sensor 604 will not require power from the CMS to asynchronously trigger a sampling rate change. The primary sensor sampled data 606 is collected from both primary sensors. The companion sensor data 608 is collected from the companion sensor. The companion sensor data may be binary data. All three streams of sampled data are input to a data processing device for data processing such as data filtering, processing, and conversion to usage data. Data processing may occur in the CMS monitor or in another device separate from the CMS monitor yet equipped to perform CMS data processing. The Final MRD usage data is the output from the data post-processing.

Using the companion sensor in conjunction with the primary sensor, as discussed above, greatly reduces the risk of misreading due to environmental effects (such as placing the device next to a refrigerator), since there are two distinct types of data being measured it would be necessary for both data types to register a false positive at the same point in time. Additionally, the increased sampling rate of the primary sensor further reduces risk of errors by separating noise interferes from the signal using signal processing methods. In spite of this, for ultra-low power and small form factors, the companion sensor can be used as a standalone detection system if accuracy of data collection is not a significant motivation for operation.

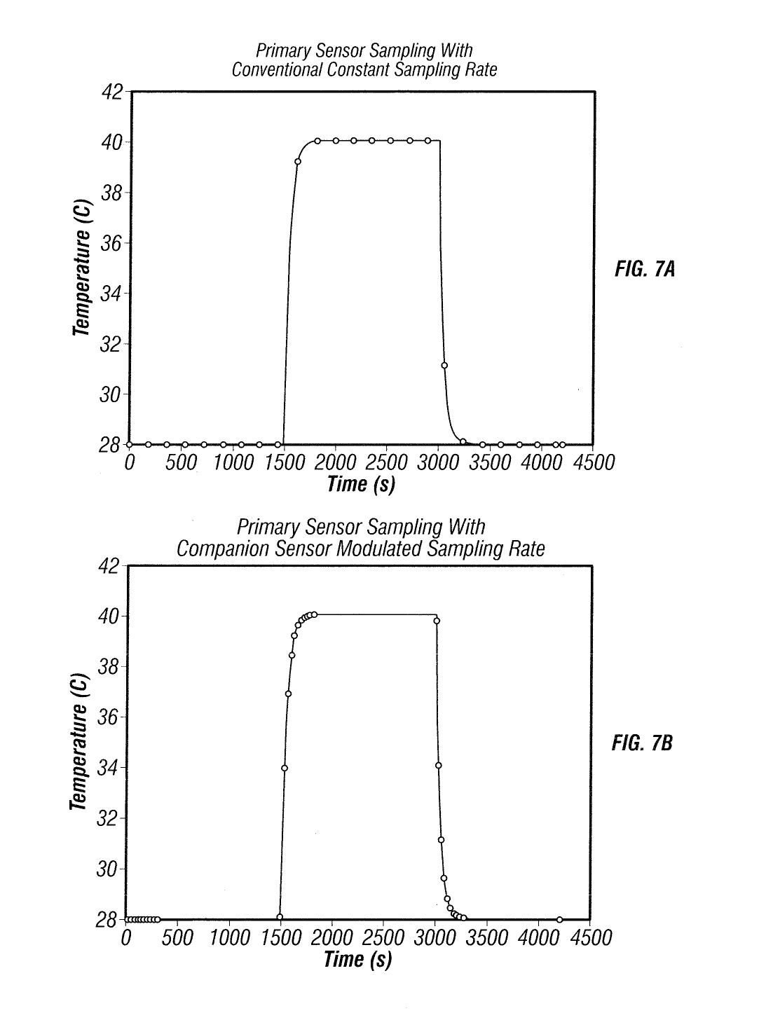

FIGS. 7A and 7B depict the difference between sampling with an unmodulated primary sensor and a primary sensor modulated by a companion sensor in accordance with embodiments of the present invention. In FIG. 7A, the primary sensor maintains a constant rate of modulation. It does not perform burst sampling at transition states (in this example, the transition state is registered by the change in temperature from 28° C. to 40° C. and from 40° C. to 28° C.). Also as shown in FIG. 7A the primary sensor never enters an idle state to conserve power. The primary sensor configuration depicted in FIG. 7A would be less accurate, due to its lack of burst sampling at transition states, and would also be energy inefficient due to its constant sampling rate which continues even during long periods of stable measurements and inactivity. FIG. 7B depicts a primary sensor modulated by a companion sensor. The example sensor configuration in FIG. 7B depicts the primary sensor only performing burst sampling at device initiation and at the edges of both transition states (i.e. when the companion sensor has been tripped). The higher rate of sampling at the edges of the transition states provides a more accurate accounting of data for measuring MRD usage, and the decrease in sampling rate as the primary sensor enters its idle state conserves energy and prolongs the life of the battery of the CMS.

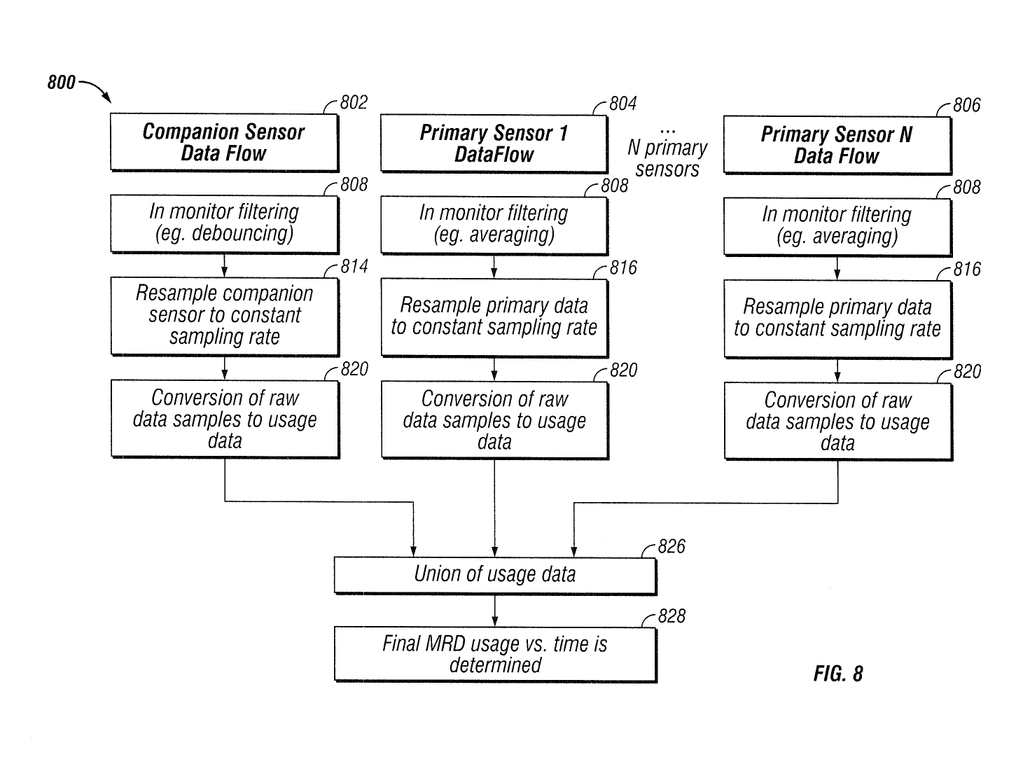

FIG. 8 is a data processing flowchart in accordance with embodiments of the present invention. CMS System 800 comprises a data processing system and methods. Companion sensor data flow 802 and primary sensor 1 data flow 804 may be processed within the CMS monitor and/or in a data processing device. Additional primary sensors N data flow 806 may also be processed and/or in a data processing device if additional primary sensors N are present. All sensor data flows (e.g. companion sensor data flow 802, primary sensor 1 data flow 804, and primary sensor N data flow 806) may be filtered by block 808. This filtering may comprise, without limitation, deglitching, debouncing, low-pass filtering, averaging, or any other sufficient filtering method. Since the companion sensor modulates the sampling rate, the data-processing unit may resample the raw data into a constant sampling rate as shown in the next step where the CMS system resamples companion sensor data to a constant sampling rate 814 and also resamples any and all primary sensor data to a constant sampling rate 816. Then the conversion of raw data samples to usage data 820 through one of many algorithms occurs and the data is unionized as depicted by block 826 in the step called the union of usage data. In every algorithm, an option filtering step can be added. Filtering may include, low-pass filtering, high-pass filtering, bandpass filtering, or windowing. Finally, the final MRD usage is versus the time of usage is determined as shown by block 828.

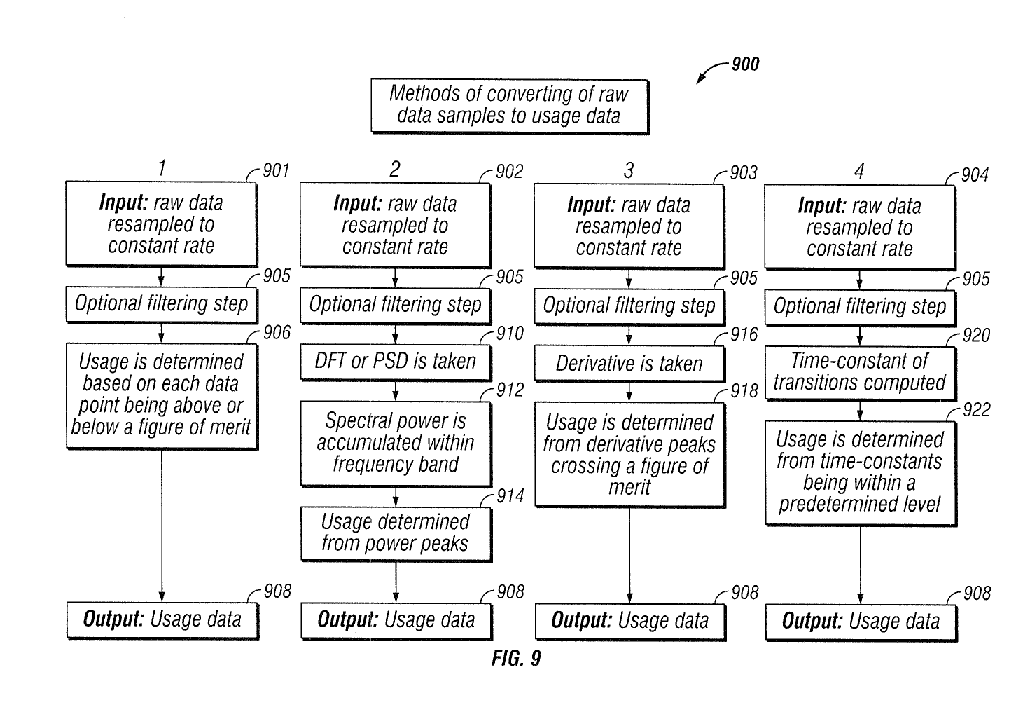

FIG. 9 illustrates four methods of data processing in accordance with embodiments of the present invention. CMS System 900 comprises a data processing system and methods. It is to be understood that these four methods are exemplary only, and the data processing methods used by the CMS apparatus or in the methods described herein should not be construed to be limited to the examples presented here, but may be any practical data processing method as would occur to one having ordinary skill in the art. Additionally as discussed above, these data processing methods may occur within the CMS, in a separate data processing device, or in a combination of both. Likewise although one data processing method may provide sufficient usage data as an output, the data processing may not be limited to one method, but may encompass many methods used independently or synergistically to provide an output of usage data that has been processed through a multitude of data processing methods.

In method 1, the input is obtained. This is depicted by block 901 where the input is the raw data resampled to a constant rate. Next the raw data may be filtered in optional filtering steps 905. Then usage is determined based on each data point being above or below a figure of merit as depicted by block 906. A figure of merit is a pass/fail reference figure. The figure of merit is either computed from points in the data set (either the partial data set or the entire data set may be used) or can be set at a predefined level. Each resampled data point is compared against the figure of merit to determine whether the device was used at that time to generate usage data. Once the comparison is made usage data can be obtained. The usage data is the output, referenced in block 908 as Output: usage data.

In method 2, the input is obtained. This is depicted by block 902 where the input is the raw data resampled to a constant rate. Next the raw data may be filtered in optional filtering steps 905. The spectral content of the resampled data is used to determine usage via the discrete Fourier transform (DFT) or periodogram (PSD). The DFT or PSD is taken in block 910. The DFT or PSD is taken in a window and the window slides across time. A lower and upper frequency limit is defined, and the spectral energy within this frequency band is accumulated for each time point, as shown by block 912 where the spectral power is accumulated within a frequency band. A figure of merit is derived either from the data set or as a pre-defined level. Usage transition data is determined from comparing the accumulated power across time against the figure of merit. Peaks above the figure of merit are interpreted as usage transition data as shown in block 914 where the usage is determined from power peaks. Usage transition data is then converted into usage data by filling usage between transition edges. Once the comparison and filtering is done, the usage data can be obtained. The usage data is the output, referenced in block 908 as Output: usage data.

In method 3, the input is obtained. This is depicted by block 903 where the input is the raw data resampled to a constant rate. Next the raw data may be filtered in optional filtering steps 905. The derivative of the resampled data is taken as shown in block 916. Each derivative point is compared against a figure of merit. The figure of merit is either computed from points in the data set (either the partial data set or the entire data set may be used) or can be set as a predefined level. The figure of merit is set at both a positive and negative level to capture rising and falling derivatives. Each resampled derivative point is compared against the figure of merit to determine usage transition data as shown by block 918 where the usage is determined from the derivative peaks crossing the figure of merit value. Usage transition data is then converted into usage data by filling usage between transition state edges. Once the comparison and filtering is done, the usage data can be obtained. The usage data is the output, referenced in block 908 as Output: usage data.

In method 4, the input is obtained. This is depicted by block 904 where the input is the raw data resampled to a constant rate. Next the raw data may be filtered in optional filtering steps 905. In this method the usage data is derived by extracting time-constants from the resampled data. The time-constants are determined in block 920 where the time-constant of transitions is computed. Time-constants of waveforms that fall within a predetermined range are used to determine usage transition data as shown in block 922 where the usage is determined from time-constants being within a predetermined level. Usage transition data is then converted into usage data by filling usage between transition state edges. Once the comparison and filtering is done, the usage data can be obtained. The usage data is the output, referenced in block 908 as Output: usage data.

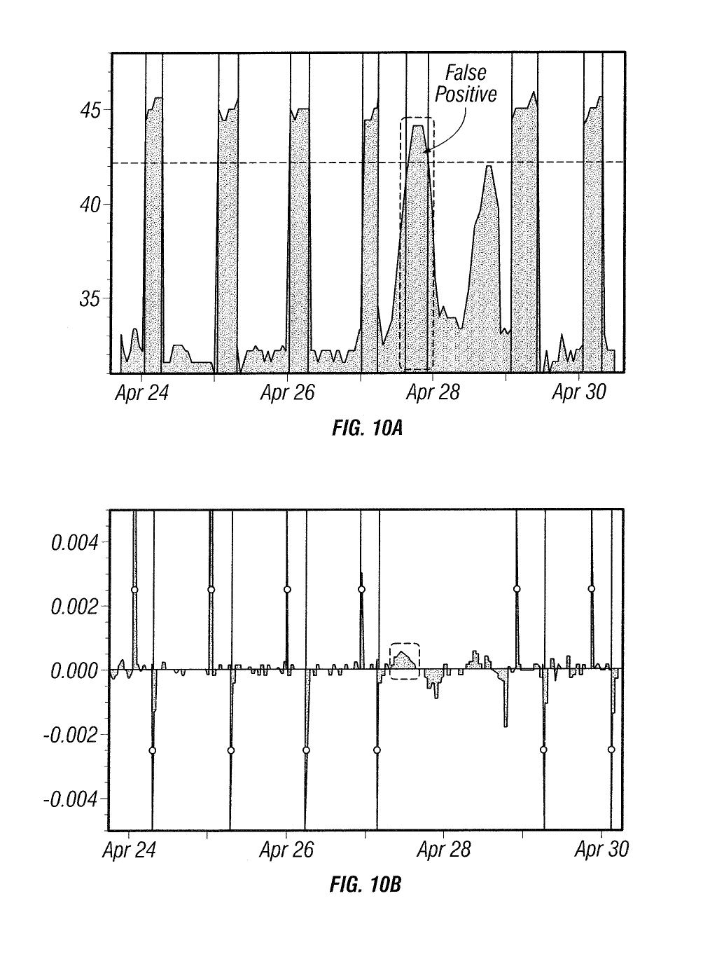

As discussed above, numerous non-idealities and noise sources may distort the measurements of the primary sensor, lowering the signal-to-noise ratio and resulting in false positives or false negatives. One popular and low cost primary sensor, the temperature transducer, may be especially susceptible to ambient temperature fluctuations from external sources such as sunlight or air conditioning. However, even with well calibrated temperature sensors, uncontrolled environment and background temperature variations can easily lead to negative noise margins and false detection. FIG. 10A depicts an example of a false positive created by an external source. FIG. 10A is a plot of temperature versus time. Time is depicted on the x-axis, with the false positive occurring at the data point of April 28^{th}. Temperature is depicted on the y-axis.

Since the underlying thermo-dynamics of the noise sources are very different from that of the signal, they exhibit different rates of change and may be separated from the signal by analyzing the rate-of-change information (e.g. derivative, time-constants, or the frequency spectrum). This process dramatically improves the signal-to-noise ratio. FIG. 10B is a plot of the derivative of the temperature value versus time illustrated improvement of the signal-to-noise ratio in accordance with embodiments of the present invention. Time is depicted on the x-axis, with the false positive occurring at the data point of April 28^{th}. The derivative of the temperature value is depicted on the y-axis. For example, when high sampling rates are used, the derivative signature of the signal can be differentiated from that of any interference as seen in FIG. 10B at the April 28 data point. The noise is suppressed and filtered out and the signal is precisely detected, thereby vastly improving the signal-to-noise ratio over state-of-the-art detection methods. The companion sensor system enables increased sampling rates which are required for using these novel methods to determine usage and compliance.

The discussion above has focused primarily on embodiments of the invention for use with compliance monitors for MRDs. Other embodiments may be used with other types of portable healthcare monitors with the motivation of extending the periods of data recording and the life of the monitors. Any monitor may work, but those monitors worn on the human body will be especially suited for application of the CMS.

It should be understood that while the apparatus and methods are described in terms of “comprising,” “containing,” or “including” various components or steps, the apparatus and methods can also “consist essentially of” or “consist of” the various components and steps. Moreover, the indefinite articles “a” or “an,” as used in the claims, are defined herein to mean one or more than one of the element that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Although individual embodiments are discussed, the invention covers all combinations of all those embodiments. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative embodiments disclosed above may be altered or modified and all such variations are considered within the scope and spirit of the present invention. If there is any conflict in the usages of a word or term in this specification and one or more patent(s) or other documents that may be incorporated herein by reference, the definitions that are consistent with this specification should be adopted.

What is claimed is:

1. A compliance monitoring system comprising:
at least one primary sensor,
a companion sensor,
and a micro-controller; and
wherein the compliance monitoring system is configured for and capable of measuring usage data of a healthcare monitor or apparatus.

2. The compliance monitoring system of claim 1, wherein the companion sensor modulates the data sampling rate of at least one primary sensor.

3. The compliance monitoring system of claim 1, wherein the primary sensors have at least one sensor selected from the group consisting of a thermocouple, a pressure sensor, an accelerometer, an electro-chemical sensor, a gyroscope, a ph meter, a pulse oximeter, a bio-chemical sensor, a humidity sensor, a microphone, a vibration sensor, and any combination thereof.

4. The compliance monitoring system of claim 1, wherein the companion sensor is selected from the group consisting of a magnet with magnetic relay, a piezoelectric sensor, a mechanical switch, an RF electromagnetic field generator with antenna, an orientation tilt sensor, and any combination thereof.

5. The compliance monitoring system of claim 1, wherein the compliance monitoring system is configured for use with and measures usage data of a mandibular repositioning device.

6. The compliance monitoring system of claim 5, wherein the companion sensor is disposed on the mandibular repositioning device.

7. The compliance monitoring system of claim 5, wherein the companion sensor is comprised of at least two components and wherein at least one component is not disposed on the mandibular repositioning device.

8. The compliance monitoring system of claim 1, wherein the primary sensor samples measurement data at a nominal sampling rate until receiving a trigger response from the companion sensor to increase the nominal sampling rate to a higher sampling rate; and wherein the measurement data collected by the primary sensor and companion sensor is stored on non-volatile memory, transferred in real-time to a data processing device, or is stored on non-volatile memory and transferred in real-time to a data processing device.

9. The compliance monitoring system of claim 8, wherein the primary sensor and companion sensor measurement data is processed by a data processing technique within the compliance monitoring system, within a separate data processing device, or within a combination of the two; wherein the data processing technique produces an output of processed data; wherein the output of processed data is a record of usage data of the healthcare monitor or apparatus; and wherein this record of usage data is transmitted to a physician.

10. The compliance monitoring system of claim 1, wherein the transmission of any usage data is done by at least one method selected from the group consisting of active RF, RFID, a wire interface, an infrared link, an optical link, and any combination thereof.

11. A method for determining the amount of usage of a healthcare monitor or apparatus comprising:
providing at least one primary sensor,
providing a companion sensor,
providing a micro-controller;
wherein the primary sensor, the companion sensor, and the micro-controller comprise a compliance monitoring system; and
wherein the a compliance monitoring system samples measurements at a default nominal sampling rate via a primary sensor, modulates the measurement sampling rate of all primary sensors via the companion sensor, and collects measurement data from the primary and companion sensors via the micro-controller.

12. The method of claim 11, wherein the measurement data collected by the primary sensor and companion sensor is stored on non-volatile memory, transferred in real-time to a data processing device, or is stored on non-volatile memory and transferred in real-time to a data processing device.

13. The method of claim 11, wherein the primary sensor and companion sensor measurement data is processed by a data processing technique within the compliance monitoring system, within a separate data processing device, or within a combination of the two; wherein the data processing technique produces an output of processed data; wherein the output of processed data is a record of usage data of the mandibular repositioning system; and wherein this record of usage data is transmitted to a physician.

14. The method of claim 13, wherein the data processing technique is at least one data processing technique selected from the group consisting of: comparing each data point to a figure of merit, using spectral analysis techniques such as the Fourier transform or periodogram to compare power within a frequency band against a figure or merit, taking the derivative of the sampled data and comparing it to a figure of merit, and calculating the time-constants of the transition and comparing them with a pre-determined level.

15. The method of claim 11, wherein at least one of the primary sensors is selected from the group consisting of a thermocouple, a pressure sensor, an accelerometer, an electro-chemical sensor, a gyroscope, a ph meter, a pulse oximeter, a bio-chemical sensor, a humidity sensor, a microphone, a vibration sensor, and any combination thereof.

16. The method of claim 11, wherein the companion sensor is selected from the group consisting of a magnet with magnetic relay, a piezoelectric sensor, a mechanical switch, an electromagnetic field generator with antenna, an orientation tilt sensor, and any combination thereof.

17. The method of claim 11, wherein the compliance monitoring system is disposed on a mandibular repositioning device.

18. The method of claim 17, wherein the companion sensor is comprised of at least two components and wherein at least one component is not disposed on the mandibular repositioning device.

19. The method of claim 11, wherein the transmission of any measurement data is done by at least one method selected from the group consisting of active RF, RFID, a wire interface, an infrared link, an optical link, and any combination thereof.

20. A method for determining the amount of usage of a mandibular repositioning device comprising:
providing at least one primary sensor,
providing a companion sensor,
providing a micro-controller;
wherein the primary sensor, the companion sensor, and the micro-controller comprise a compliance monitoring system;
wherein the compliance monitoring system is disposed on a mandibular repositioning device;
wherein the compliance monitoring system samples measurements at a default nominal sampling rate via a primary sensor, modulates the sampling rate of all primary sensors via the companion sensor, and collects measurement data from the primary and companion sensors via the micro-controller;
wherein at least one of the primary sensors is selected from the group consisting of a thermocouple, a pressure sensor, an accelerometer, an electro-chemical sensor, a gyroscope, a ph meter, a pulse oximeter, a bio-chemical sensor, a humidity sensor, a microphone, a vibration sensor, and any combination thereof;
wherein the companion sensor is selected from the group consisting of a magnet with magnetic relay, a piezoelectric sensor, a mechanical switch, an electromagnetic field generator with antenna, an orientation tilt sensor, and any combination thereof;
wherein the collected measurement data is analyzed by a data processing technique performed by the compliance monitoring system, by a separate data processing device, or by a combination of the two;
wherein the data processing technique is at least one data processing technique selected from the group consisting of: comparing each data point to a figure of merit, using spectral analysis techniques such as the Fourier transform or periodogram to compare power within a frequency band against a figure or merit, taking the derivative of the sampled data and comparing it to a figure of merit, and calculating the time-constants of the transition and comparing them with a pre-determined level;
wherein the output of the data processing technique comprises mandibular repositioning device usage data;
wherein transmission of any data is done by at least one method selected from the group consisting of active RF, RFID, a wire, an infrared link, an optical link, and any combination thereof; and
wherein the mandibular repositioning device usage data is transmitted such that it may be viewed by a physician, a patient, or a combination thereof.
